(19) United States
(12) Patent Application Publication
(10) Pub. No.: US 2012/0062059 A1
(43) Pub. Date: Mar. 15, 2012

(54) Angular momentum engine

(76) Inventor: Michael J. Carew, Franklin, NJ (US)

(21) Appl. No.: 13/199,849

(22) Filed: Sep. 9, 2011

Related U.S. Application Data
(60) Provisional application No. 61/403,291, filed on Sep. 13, 2010.

(51) Int. Cl. H02K 7/06; H02K 7/18

(52) U.S. Cl. 310/81; 290/1 R

(57) ABSTRACT

This invention Angular Momentum Engine turns angular centripetal momentum to linear centripetal momentum.

As an analogy picture a small hand held battery operated clock in your hand being turned counter-clockwise at one revolution per minute. The clock battery is then remotely turned on so that the minute hand starts to turn also at one revolution per minute but in the opposite direction clockwise.

If you look at the clock the minute hand will appear to be standing still even though it is moving at 1 revolution per minute clockwise.

In this patent the hand held clock is replaced by the planetary drive and the minute hand by the flywheel. [FIG. 1 FIG. 2]

Forces from a few to millions of pounds of linear momentum can be generated.

### CROSS REFERBECE TO RELATED APPLICATIONS

This application claims cross reference to related Provisional application 61403291 Sep. 13, 2010—Angular Momentum engine.

### BACKGROUND

Twenty years ago I began looking at the possibility of designing a mechanical propulsion system, a system I believed could rival conventional jet, rocket and automotive engines. Such an idea would meet with skepticism from conventional engineering schools of thought, and look squarely at Newton's Third Law of Motion.

The result is an Angular Momentum Engine that derives linear momentum from the angular momentum of the engine.

The design, of the Angular Momentum Engine, has applications in commercial transportation, military transportation, and military defense theaters, space propulsion, as well as the generation of electricity.

The Angular Momentum Engine can produce a few pounds to million of pounds of linear momentum.

### BRIEF DEESCRIPTION OF THE DRAWINGS

FIG. 1 FIG. 2—System design FIG. 1a FIG. 2a—Data Sheets

FIG. 3—Timing Excel Spreadsheet

FIG. 4—Timing Documentation

### BRIEF DESCRIPTION OF THE INVENTION

This invention simply turns angular centripetal momentum into linear centripetal momentum.

A detailed explanation of the invention follows.

### DETAILED DESCRIPTION OF THE INVENTION

Just as linear momentum [straight-line momentum] is the inertia of an object multiplied by its velocity, angular momentum is the inertia of an object multiplied by its rotational velocity. The object, in this Angular Momentum Engine, is a mass revolving around a center point. As an analogy picture a ball revolving on the end of a string. “A fictitious or pseudo outward force on a particle rotating about an axis which by Newton's third law is equal and opposite to the centripetal force. Like all such action reaction pairs of forces, they are equal and opposite but do not cancel each other. Consider a mass M tied by a string of length R to a pin at the center of a smooth horizontal table and whirling around the pin with an angular velocity of ? radians per second. The mass rotates in a circular path because of the centripetal force Fc=M?2/R which is exerted on the mass by the string. The reaction force exerted by the rotating mass M, the so-called centrifugal force is M?2/R in a direction away from the center of rotation.”

As an example, a servomotor turning horizontally a 0.314 pound mass 6 inches from the shafts center, similar to the ball on the end of a string, will at 2,000 revolutions per minute produce a centripetal force of 286. pounds. Doubling the speed to 4000 revolutions per minute will quadruple the centripetal force to 846 lbs.

This example is identical to [0011] and [0012] below and results in only rotational and not linear or straight-line momentum.

A mass at rest accelerated to an angular momentum of 4000 rpm's clockwise will be moving at +4000 revolutions per minute.

A mass at rest accelerated to an angular momentum of 4000 rpm's counter-clockwise will be moving at −4000 revolutions per minute.,

Changing angular momentum to linear momentum simply requires changing the relative position of the centripetal force as described below. [0014-0015]

If a mass has an angular momentum of −4000 rpm's and an angular momentum of +4000 is applied to the mass it will appear to be standing still even though it is rotating +4000 rpm's clockwise.

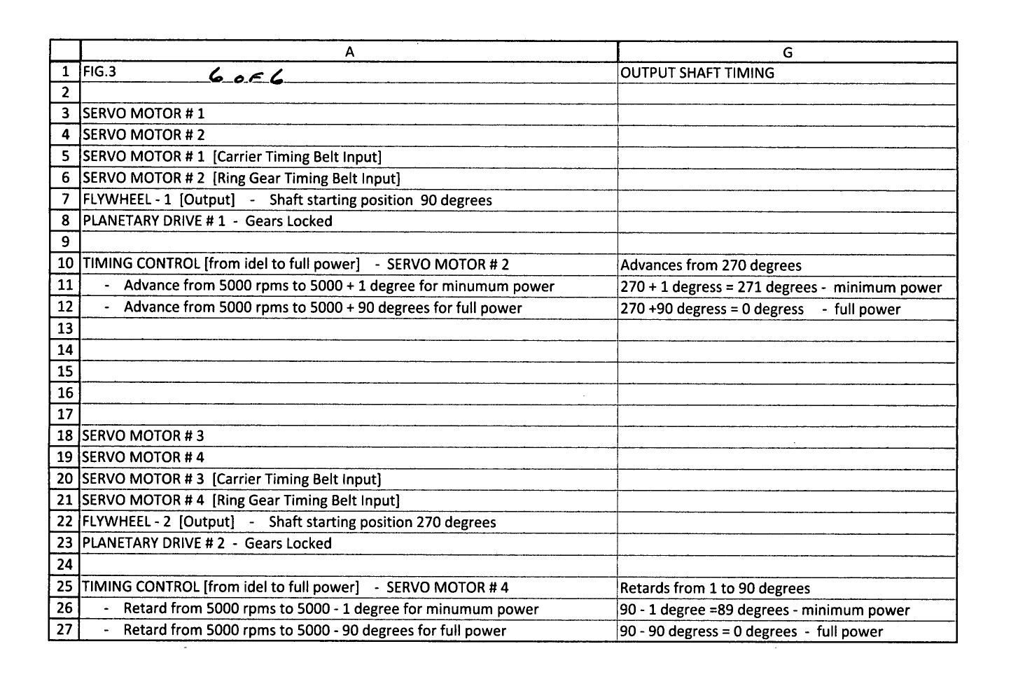

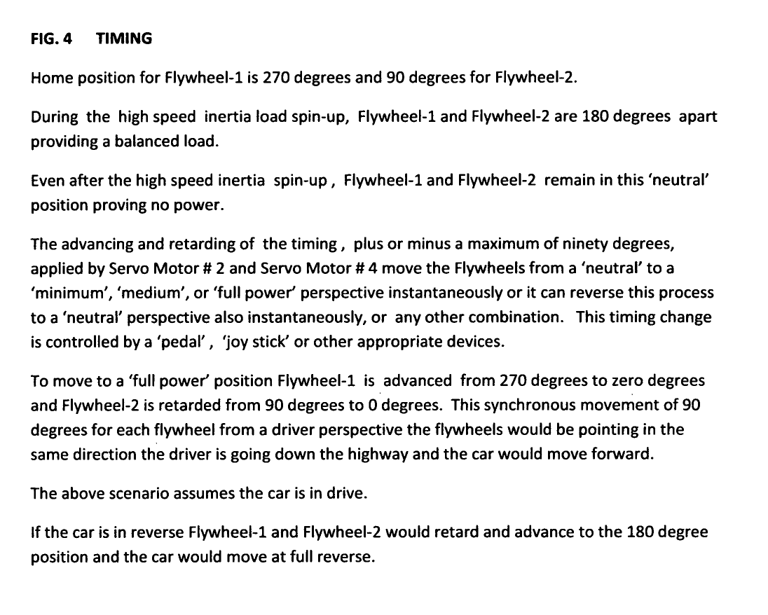

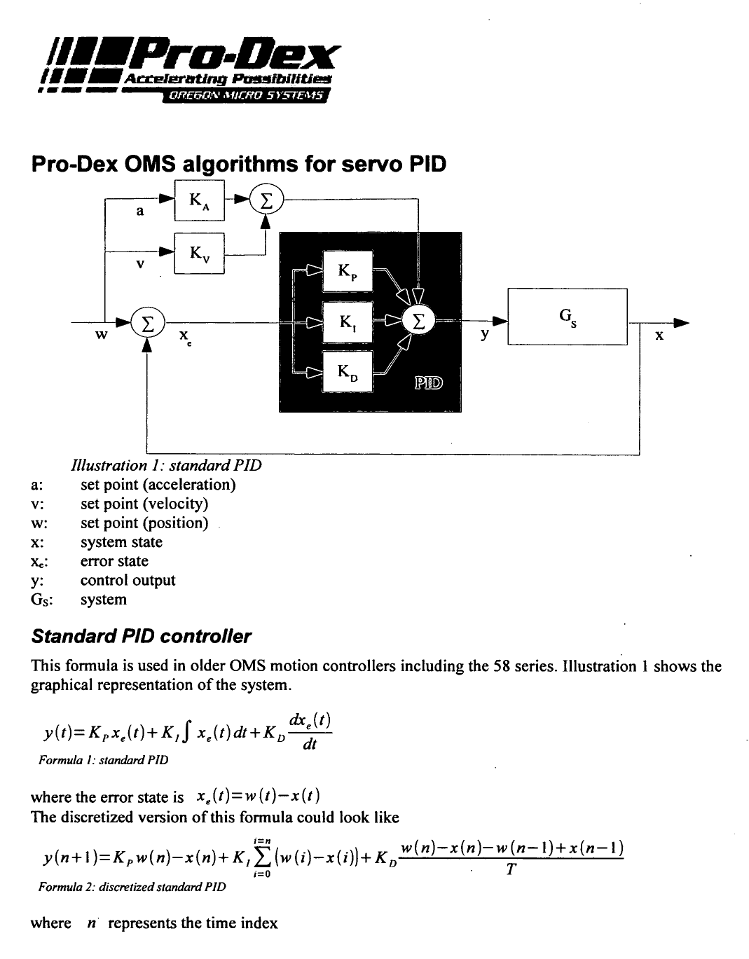

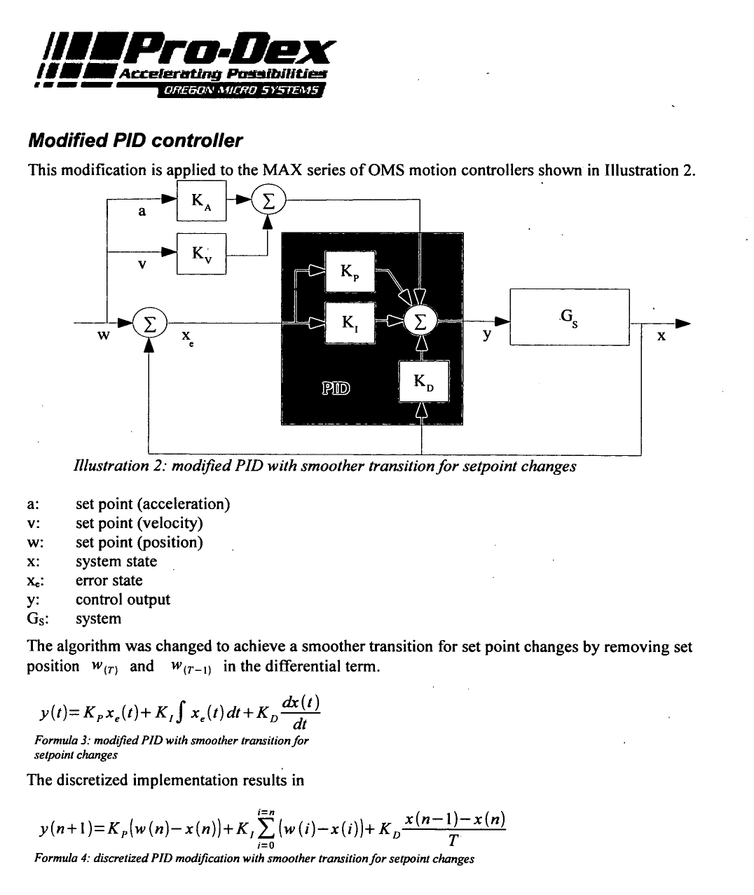

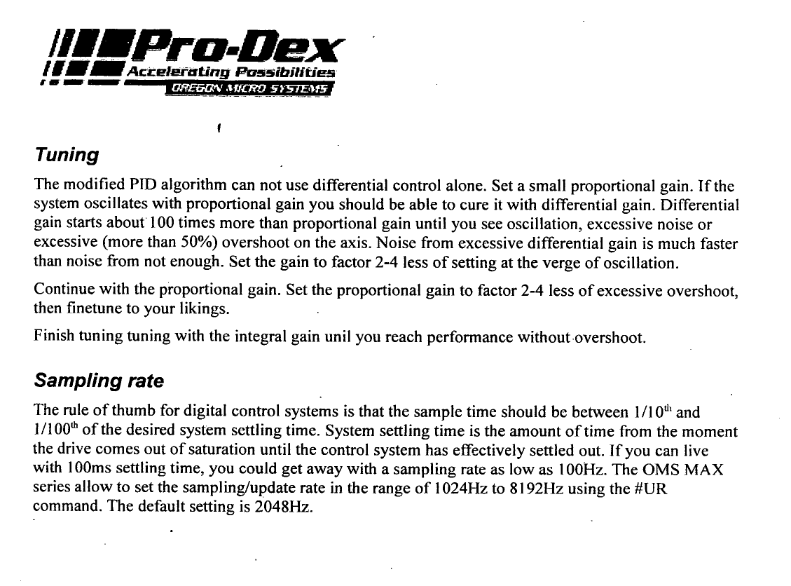

If a mass has an angular momentum of +4000 rpm's and an angular momentum of −4000 rpm's is applied to the mass it will appear to be standing still even though it is rotating −4000 rpm's counter-clockwise. FIG.4

The centripetal force applied in each of the four situations listed above [0011-0012-0014-0015} will be identical except the first two [0011] and [0012] have a rotating centripetal force the latter two [0014] and

have a linear or straight line centripetal force.

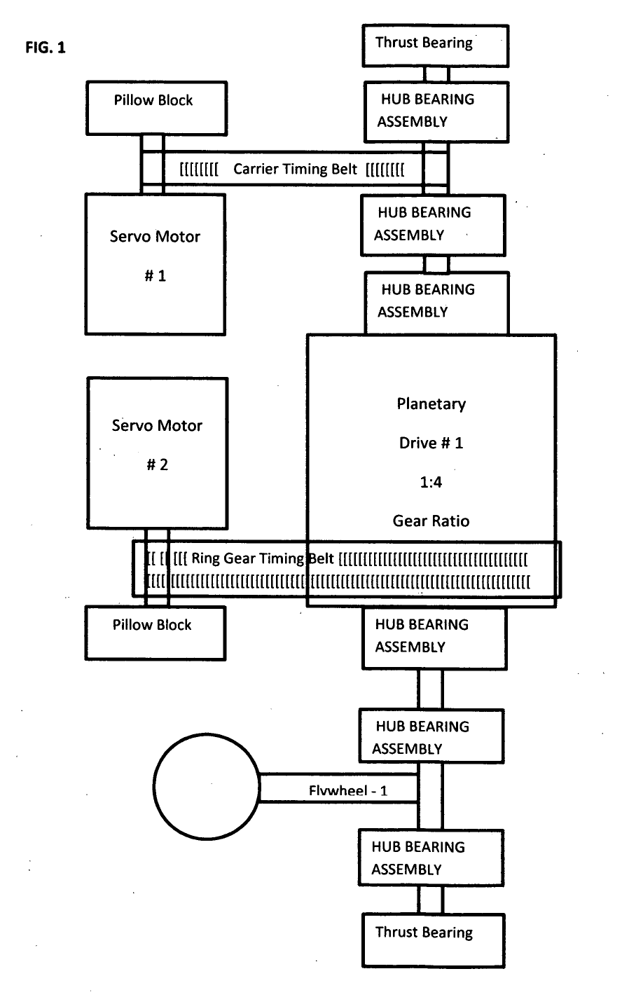

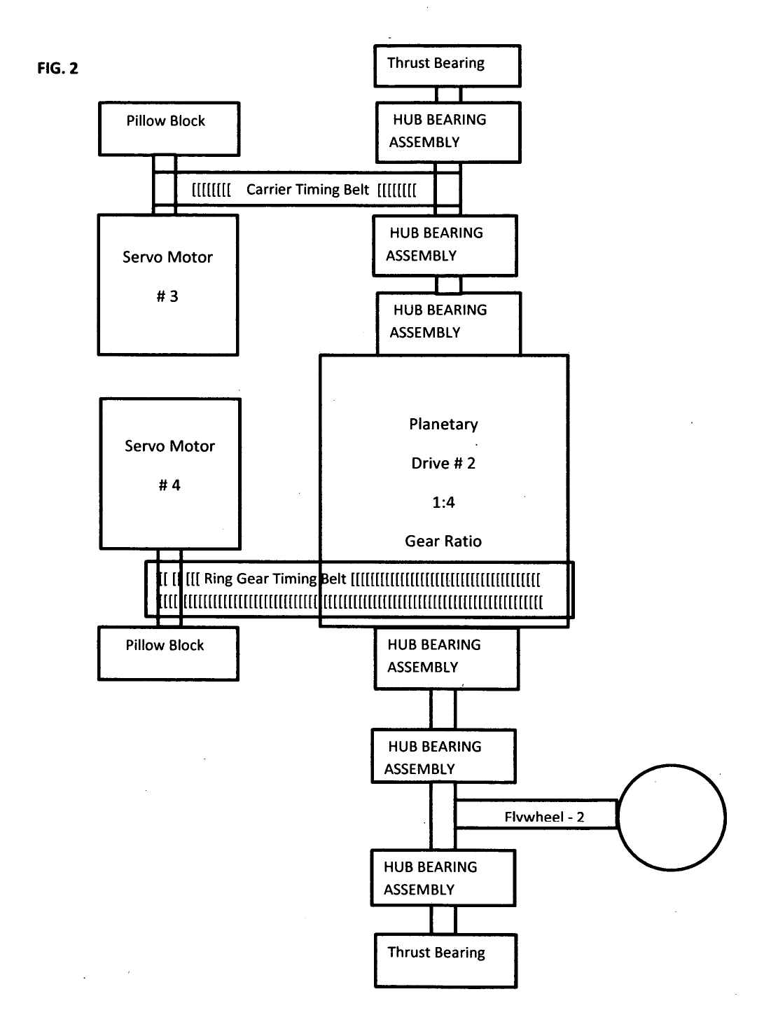

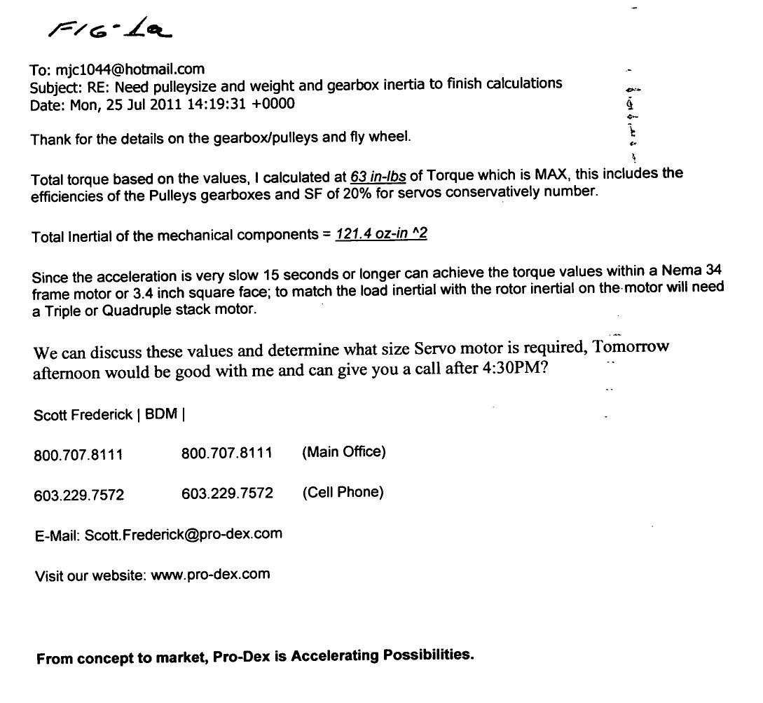

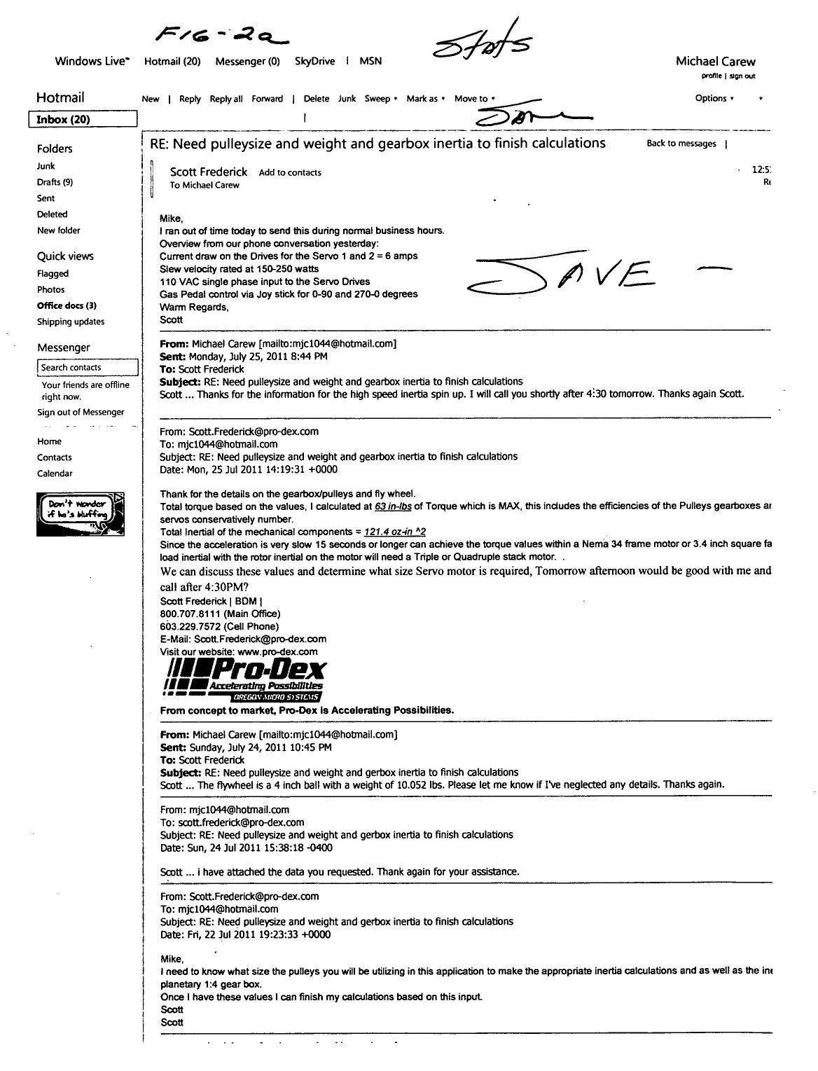

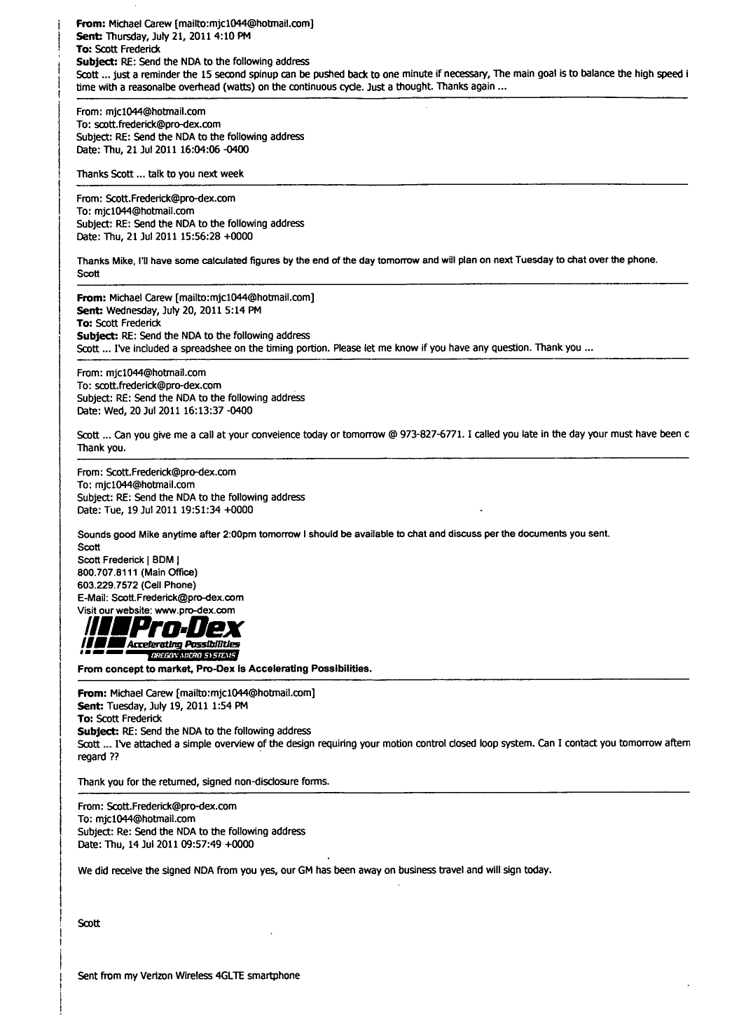

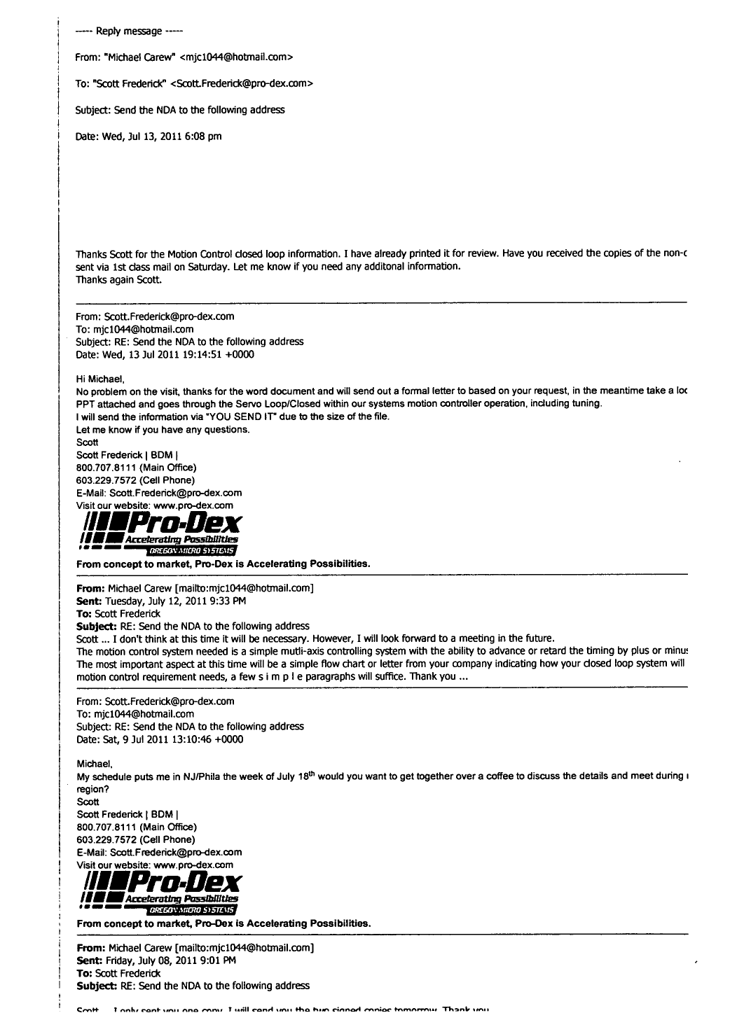

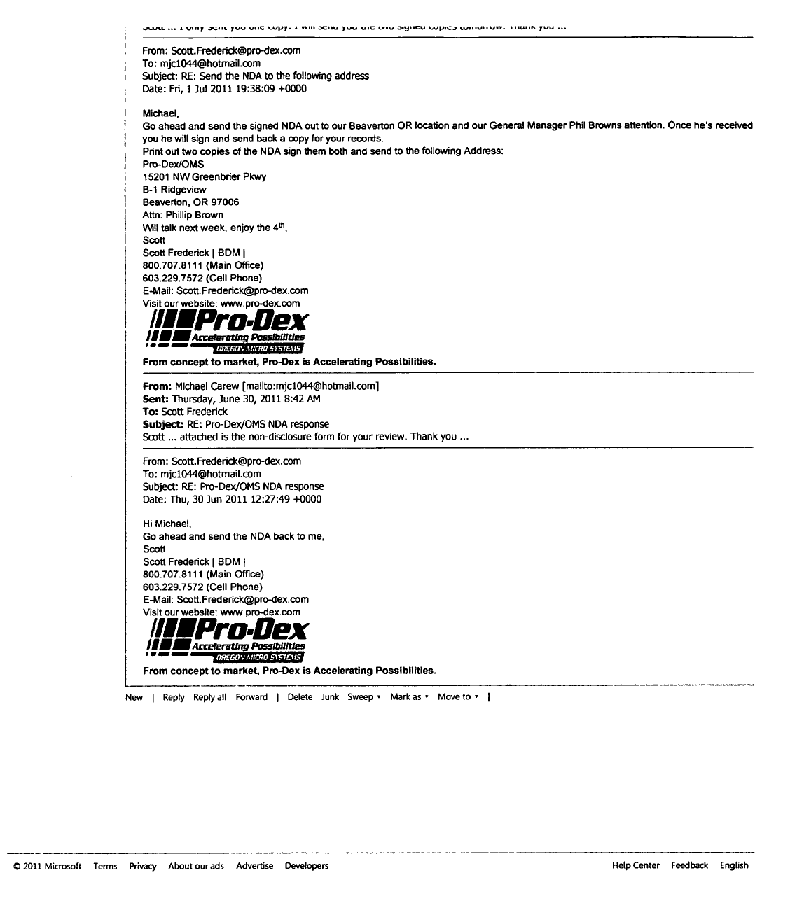

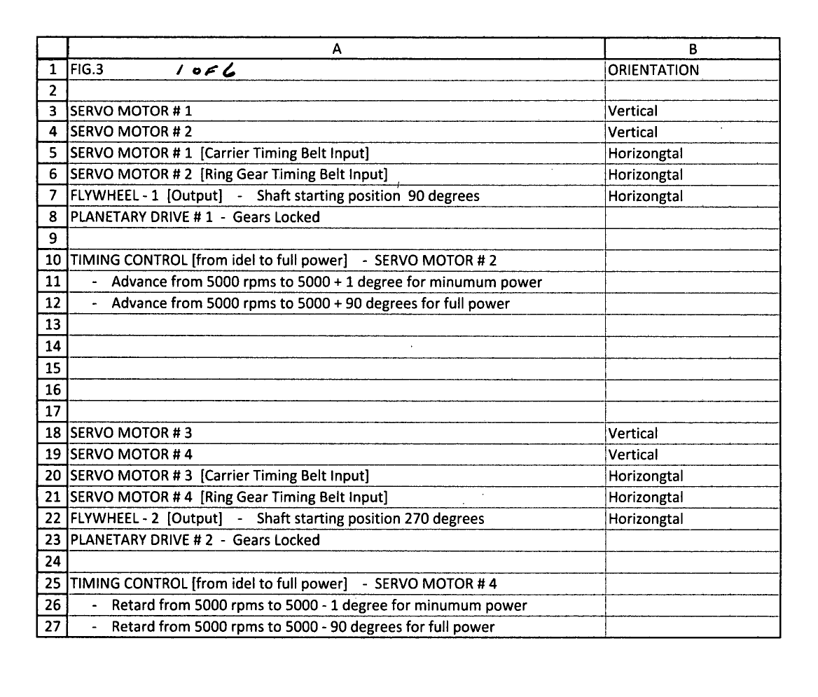

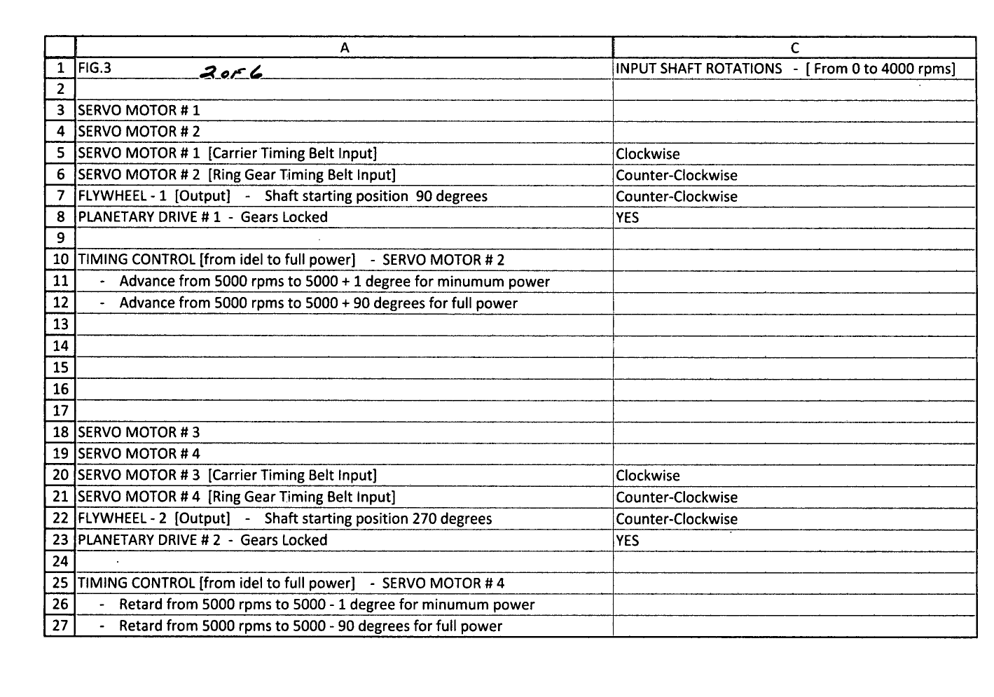

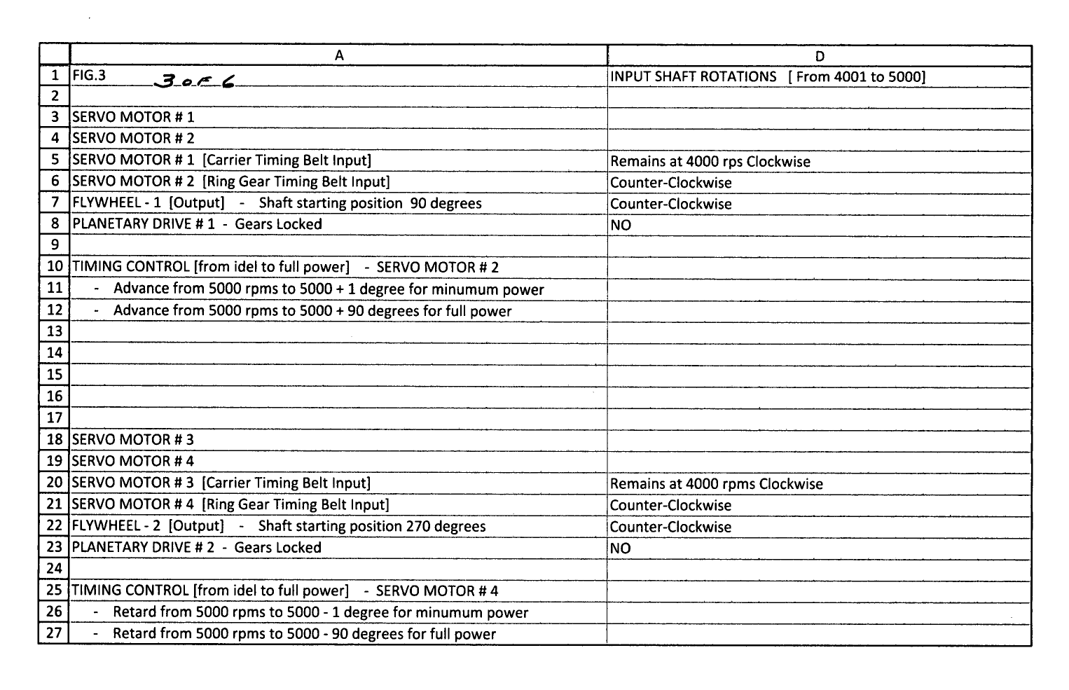

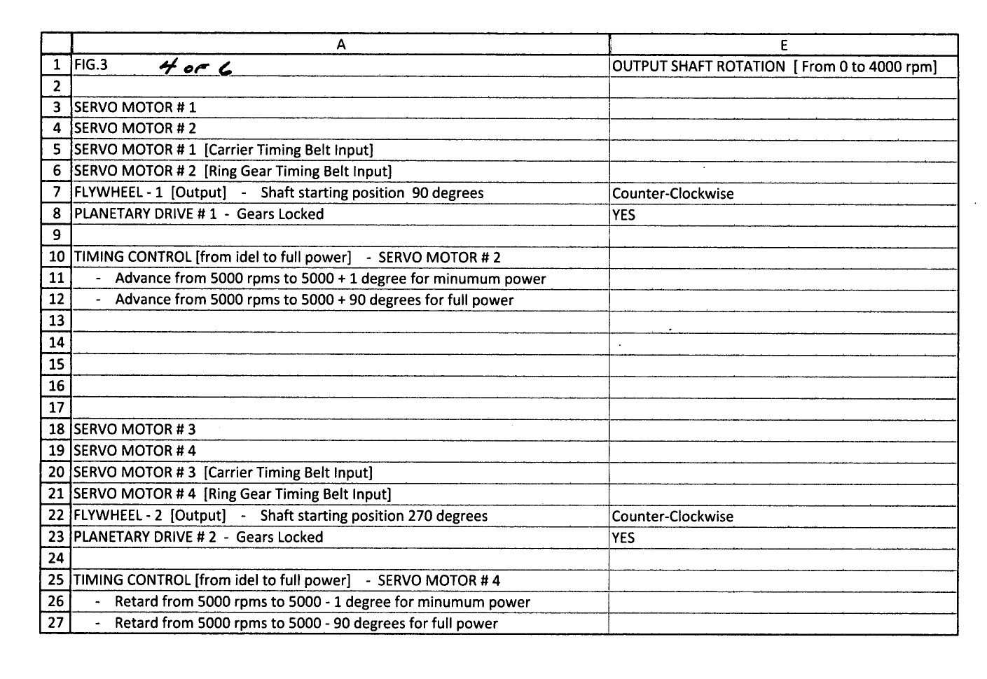

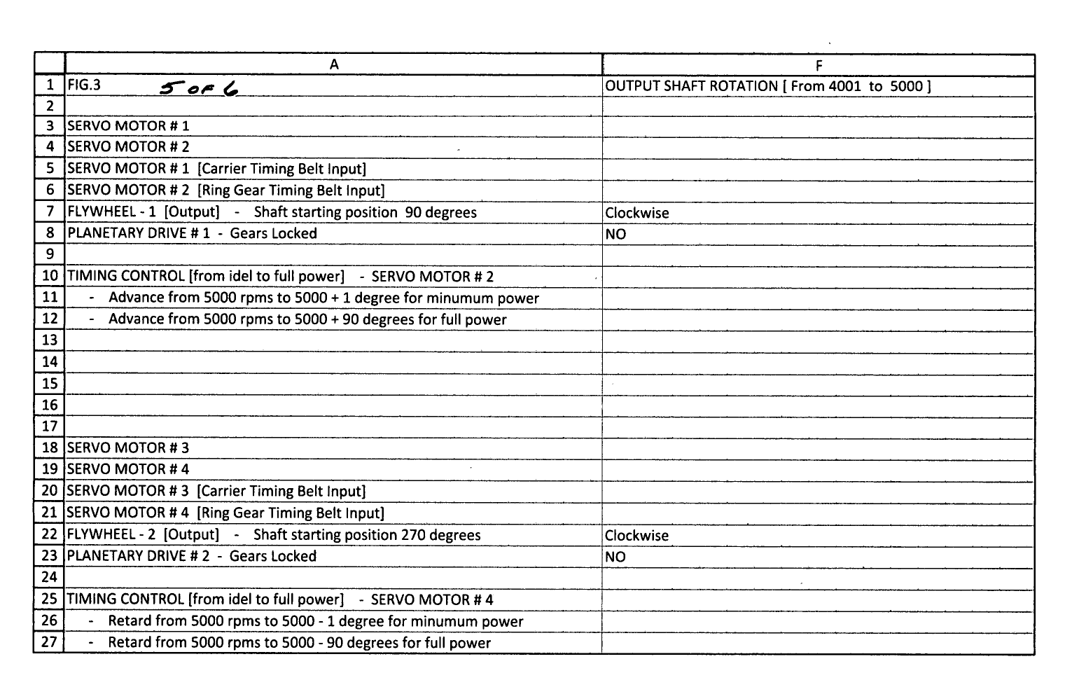

This Angular Momentum Engine uses four Servo Motors (#1, #2, #3, #4) to to rotate the planetary drives 4000 rpm's counter-clockwise. *see [0014] FIG. 1 FIG. 2. Servo Motor #1 and Servo Motor #3 turn the timing belts in synchronization with Servo Motor #2 and Servo Motor #4 that turns the timing belts.

This locks the internal gears of the planetary drive (sun, planetary, ring gear) and results in the planetary drives turning at 4000 rpm's counter-clockwise while the internal gears (sun, planetary ,ring) and the flywheels remain at rest relative to each other.
With the Servo motors #1 and #3 running at 4000 rpm's Servo motors #2 and #4 increases there speed to turn Ring gear pulley an additional 1000 rpm's to 5000 rpm's. With a 1:4 gearbox ratio this turns the sun gear output shaft at 4000 rpm's in the opposite direction it was turning.
The sun-gears output shaft is on a vertical plane and the flywheel (0.314 lb. mass) 6 inches from the output sun gears shaft center will have an axis of rotation horizontally around the sun-gears vertical shaft, like a ball on the end or a string.
The result is the conversion of Rotational Centripetal Momentum to Linear Centripetal Momentum.

The Angular Momentum engine use a digital closed loop system to control the current (and hence torque) and speed as well as positioning through encoders to allow the servo motors to convert angular centripetal momentum to linear centripetal momentum as outlined in this Patent Application. FIG. 4

It should be noted that before spin-up, as multiple independent motors are used, they must be set to 270 degrees for Flywheel-1 and 90 degrees for Fltwheel-2.
At this point the forces from Flywheel-1 and Flywheel-2 are equal and opposite. To move to full power Flywheel-1 is accelerated ninety degrees from 270 to 360 degrees via Servo Motor #2 in synchronization with Servo Motor #4 that retards Flywheel-2 ninety degrees from 90 degrees to 0 degrees.
Partial to full power is dependent on the number of degrees, 1 degree minimum power 90 degrees maximum power through an acceleration pedal or joystick.

This design offers a constant force resulting in constant acceleration without the fuel weight and bulk associated with conventional propulsion systems. Propulsion forces from a few to millions of pounds of force can be achieved.

As the electric motors are turning an unbalanced load special consideration is given to the type of bearings used in the electric motors and the operational environment in which they operate.

1. This invention Angular Momentum Engine turns angular centripetal momentum to linear centripetal momentum [straight-line momentum].
This Angular Momentum Engine claims that any process, electrical, electromechanical, mechanical, or in any combination that uses the claim [0021] is using this Angular Momentum Engine.
The linear momentum of the Angular Momentum Engine is directly related to its angular momentum. The Angular Momentum Engine can therefore produce a few pounds to millions of pounds of linear momentum.
This patent uses Albert Einstein's extended principles of relativity which states:
the laws of physics are the same everywhere.
everything works the same regardless of how fast you are moving.
you can't distinguish rest from motion, this means that all reference frames are the same and there is no absolute motion.
without a reference point at rest, all uniform motion is relative.
This patent can optionally power a generator to create current.
